(19) United States
(12) Patent Application Publication
(10) Pub. No.: US 2026/0352411 A1
(43) Pub. Date: Nov. 5, 2026

(54) ALLOCATION METHOD FOR SOUND REFERENCE SIGNAL BANDWIDTH

(71) Applicant: T-MOBILE INNOVATIONS LLC, Overland Park, KS (US)

(72) Inventor: Sanghoon SUNG, Ashburn, VA (US)

(21) Appl. No.: 19/198,922

(22) Filed: May 5, 2025

(51) Int. Cl. H04L 5/00; H04L 5/14

(52) U.S. Cl. CPC H04L 5/0051; H04L 5/0012; H04L 5/1469

(57) ABSTRACT

At a high level, the technology disclosed herein relates to Sounding Reference Signal (SRS) allocation hopping techniques (e.g., different SRS allocation hopping techniques for different types of user devices or different groupings of user devices) that improve upon prior technologies (e.g., where SRS beamforming coverage is less than other coverage forms because of user devices having limited SRS uplink transmission power). For example, if a user device is a fixed wireless access device, the SRS allocation hopping technique may include having the user device transmit each subsequent SRS transmission based on a smaller amount of physical resource blocks than each previous SRS transmission. As another example, if a user device is not a fixed wireless access device, the SRS allocation hopping technique may include having the user device transmit all SRS transmissions based on a total amount of physical resource blocks.

### SUMMARY

A high-level overview of various aspects of the invention are provided here to offer an overview of the disclosure and to introduce a selection of concepts that are further described below in the detailed description section. This summary is not intended to identify key features or essential features of the claimed subject matter, nor is it intended to be used as an aid in isolation to determine the scope of the claimed subject matter.

According to various aspects of the technology disclosed herein, systems, methods, media, etc., are provided for sounding reference signal (SRS) allocation hopping techniques. For example, a user device operating in Time Division Duplex (TDD) may be identified. A grouping or identity for the user device may be determined. Based on this determination and the user device operating in TDD, the user device can be caused to implement Sounding Reference Signal (SRS) allocation hopping (e.g., a frequency hopping pattern that scans the entire channel bandwidth).

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

### BRIEF DESCRIPTION OF THE DRAWINGS

Aspects of the present disclosure are described in detail herein with reference to the attached Figures, which are intended to be exemplary and non-limiting, wherein:

FIG. 1 depicts an example channel sounding environment;

FIG. 2 depicts an example channel reciprocity SRS beamforming environment;

FIG. 3 illustrates an example uplink channel quality scanning environment;

FIG. 4 illustrates another example uplink channel quality scanning environment;

FIG. 5 depicts an example table comparing different user device identities for beam profiling;

FIG. 6 illustrates example techniques associated with SRS allocation hopping, in accordance with embodiments herein;

FIG. 7 illustrates additional example techniques associated with SRS allocation hopping, in accordance with embodiments herein;

FIG. 8 depicts an example flowchart of the functionality associated with the present technology, in accordance with embodiments herein; and

FIG. 9 depicts an example user device and example user device functionality for implementation of the present technology, in accordance with embodiments herein.

### DETAILED DESCRIPTION

The subject matter of the present invention is being described with specificity herein to meet statutory requirements. However, the description itself is not intended to limit the scope of this patent. Rather, the inventors have contemplated that the claimed subject matter might also be embodied in other ways to include different steps or combinations of steps similar to the ones described in this document, in conjunction with other present or future technologies. Terms should not be interpreted as implying any particular order among or between various steps herein disclosed unless and except when the order of individual steps is explicitly described. As such, although the terms “step” and/or “block” may be used herein to connote different elements of systems and/or methods, the terms should not be interpreted as implying any particular order and/or dependencies among or between various components and/or steps herein disclosed unless and except when the order of individual steps is explicitly described. The present disclosure will now be described more fully herein with reference to the accompanying drawings, which may not be drawn to scale and which are not to be construed as limiting. Indeed, the present invention may be embodied in many different forms and should not be construed as limited to the aspects set forth herein.

### Definitions

Various technical terms, acronyms, and shorthand notations are employed to describe, refer to, and/or aid the understanding of certain concepts pertaining to the present disclosure. Unless otherwise noted, said terms should be understood in the manner they would be used by one with ordinary skill in the telecommunication arts. An illustrative resource that defines these terms may be found in Newton's Telecom Dictionary, (e.g., 32d Edition, 2022).

Embodiments of the technology described herein may be embodied as, among other things, a method, system, or computer-program product. Accordingly, the embodiments may take the form of a hardware embodiment, or an embodiment combining software and hardware. An embodiment takes the form of a computer-program product that includes computer-useable instructions embodied on one or more computer-readable media that may cause one or more computer processing components to perform particular operations or functions.

Computer-readable media include both volatile and nonvolatile media, removable and non-removable media, and contemplate media readable by a database, a switch, and various other network devices. Network switches, routers, and related components are conventional in nature, as are means of communicating with the same. By way of example, and not limitation, computer-readable media comprise computer-storage media and communications media.

Computer-storage media, or machine-readable media, include media implemented in any method or technology for storing information. Examples of stored information include computer-useable instructions, data structures, program modules, and other data representations. Computer-storage media include, but are not limited to RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These memory components may store data momentarily, temporarily, or permanently. “Computer storage media” does not comprise signals per se.

For purposes of this disclosure, the word “including” or “having” has the same broad meaning as the word “comprising.” Further, the word “communicating” has the same broad meaning as the word “receiving,” or “transmitting” facilitated by software or hardware-based buses, receivers, or transmitters using communication media.

In addition, words such as “a” and “an,” unless otherwise indicated to the contrary, include the plural as well as the singular. Thus, for example, the constraint of “a feature” is satisfied where one or more features are present. Additionally, an element in the singular may refer to “one or more.”

The term “some” may refer to “one or more.”

The term “or” includes the conjunctive, the disjunctive, and both (a or b thus includes either a or b, as well as a and b).

The phrase “one or more combinations thereof” may refer to, for example, “at least one of A, B, or C”; “at least one of A, B, and C”; “at least two of A, B, or C” (e.g., AA, AB, AC, BB, BA, BC, CC, CA, CB); “each of A, B, and C”; and may include multiples of A, multiples of B, or multiples of C (e.g., CCABB, ACBB, ABB, etc.). Other combinations may include more or less than three options associated with the A, B, and C examples.

Unless specifically stated otherwise, descriptors such as “first,” “second,” and “third,” for example, are used herein without imputing or otherwise indicating any meaning of priority, physical order, arrangement in a list, or ordering in any way, but are merely used as labels to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name.

### Technological Overview

By way of background, Sounding Reference Signal (SRS) beamforming coverage is generally less than other forms because of user equipment SRS transmission power being limited (e.g., 23 dBm or 26 dBm) for uplink. As an example, 100 MHz SRS transmission may have a corresponding UE SRS transmission power spectral density of 23 dBm/273 physical resource blocks (PRBs), whereas both a precoding matrix indicator (PMI) based beamforming coverage with UE feedback on PMI index and a Synchronization Signal Block (SSB) beamforming coverage with UE feedback on SSB index having the corresponding feedback transmission power density at 23 dBm/1 PRB or higher. As such, UEs can transmit PMI or SSB feedback signals to a node (e.g., gNodeB) from much further away than UEs transmitting SRS signals.

SRS can be used for uplink channel sounding, which allows the network to measure channel conditions and to provide beamforming (e.g., in 5G networks). For example, upon the network accessing the channel conditions from an SRS uplink between a UE and a network node (e.g., gNodeB), the network may optimize beamforming and other techniques, improving overall communication quality and performance. Uplink channel sounding can include a UE sending SRS for the network node or network computing components to identify path loss, delay, Doppler shift, multipath fading, etc., so that beamforming modifications can be implemented to reduce interference or to improve signal strength and quality. For example, the SRS information (e.g., channel state information) can allow for antenna beam steering (e.g., beam direction and shape configurations).

The present technology improves upon these technological problems associated with SRS beamforming coverage UE SRS transmission power limitations. For example, the methods, systems, media, techniques, etc., provided include improvements on UE SRS transmission power and the ability of network nodes to receive SRS feedback from UEs located further away than traditional methods have allowed for. In an embodiment, a method comprises identifying a user device operating in Time Division Duplex (TDD) and determining a grouping or an identity for the user device. The method may also comprise causing the user device to implement Sounding Reference Signal (SRS) allocation hopping based on the grouping or identity and based on the user device operating in TDD or utilizing a TDD uplink.

In some embodiments, the method may also comprise determining the grouping or identity for the user device is a fixed wireless access (FWA) device and then causing the SRS allocation hopping to include SRS transmissions by the FWA device to a network node, such that each subsequent SRS transmission has a smaller amount of physical resource blocks than a previous SRS transmission. In embodiments, the SRS allocation hopping may include the FWA device taking an SRS measurement based on a first amount of physical resource blocks and a subsequent SRS measurement based on a second amount of physical resource blocks that is a smaller amount of physical resource blocks than the first amount. In some embodiments, each SRS transmission from the FWA is caused to occur within a predetermined time frame for all of the SRS transmissions (e.g., each SRS transmission occurring within 20 milliseconds). In some embodiments, each subsequent SRS transmission is caused to occur at a higher frequency than the previous SRS transmission.

In some embodiments, the method may also comprise determining the grouping or identity for the user device is an Enhanced Mobile Broadband device (eMBB), and then causing the SRS allocation hopping to include SRS transmissions by the eMBB device, each of the SRS transmissions having a total amount of physical resource blocks. Stated differently, each of the SRS transmissions by the eMBB device would have the same corresponding amount of physical resource blocks. In embodiments, a network node may receive a set of SRS transmissions, based on the SRS allocation hopping, from the eMBB device that each measured an entire channel bandwidth. Additionally or alternatively, the network node may receive a set of SRS transmissions, based on the SRS allocation hopping, from the FWA device that measured different portions of channel bandwidth using the different SRS measurements. In some embodiments, the network node may cause the user device to perform the allocation hopping based on an equation of Y(n)=a*X(n)+b, where b=Mod k (PCI).

In another example embodiment, one or more computer storage media is provided. The media has computer-executable instructions embodied thereon, that when executed by at least one processor, cause the at least one processor to perform a method. The method comprises identifying a user device operating in Time Division Duplex (TDD) and determining a grouping or identity for the user device. The method also comprises causing the user device to implement Sounding Reference Signal (SRS) allocation hopping. The method also comprises receiving SRS transmissions from the user device based on the SRS allocation hopping.

In some embodiments, the method may also comprise determining the user device is a fixed wireless access (FWA) device, and then causing the SRS allocation hopping to include an SRS measurement based on a first amount of physical resource blocks and a subsequent SRS measurement based on a second amount of physical resource blocks that is a smaller amount than the first amount. The method may also comprise causing the SRS allocation hopping to include a third SRS measurement based on a third amount of physical resource blocks and a fourth SRS measurement based on a fourth amount of physical resource blocks, wherein the third amount is a smaller amount than the second amount, and the fourth amount is a smaller amount than the third amount. The method may also comprise receiving the SRS transmissions including the SRS measurement at a first time, the subsequent SRS measurement at a second time, the third SRS measurement at a third time, and the fourth SRS measurement at a fourth time, wherein durations between the first time and the second time, the second time and the third time, and third time and the fourth time are equal amounts of time.

In some embodiments, the method may also comprise determining the grouping for the user device is an Enhanced Mobile Broadband device (eMBB) and causing the SRS allocation hopping to include SRS measurements each based on a total amount of physical resource blocks. The method may further comprise receiving the SRS transmissions, including the SRS measurements, each within a subsequent time frame, each corresponding to an entire channel bandwidth.

In another example embodiment, a system is provided. The system comprises at least one processor and computer storage media having computer-executable instructions embodied thereon, that when executed by the at least one processor, cause the at least one processor to perform operations. The operations may include determine an identity for a user device operating in Time Division Duplex (TDD), cause the user device to implement Sounding Reference Signal (SRS) allocation hopping, and receive SRS transmissions from the user device based on the SRS allocation hopping.

### Example Operating Environments

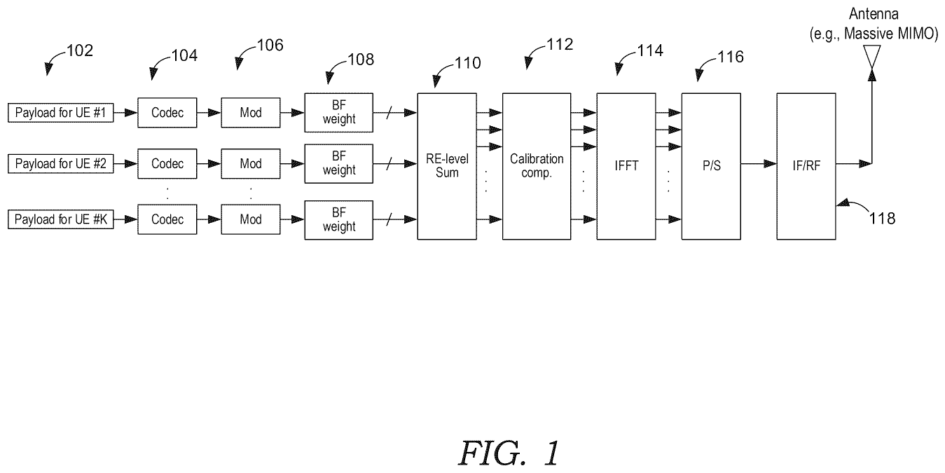

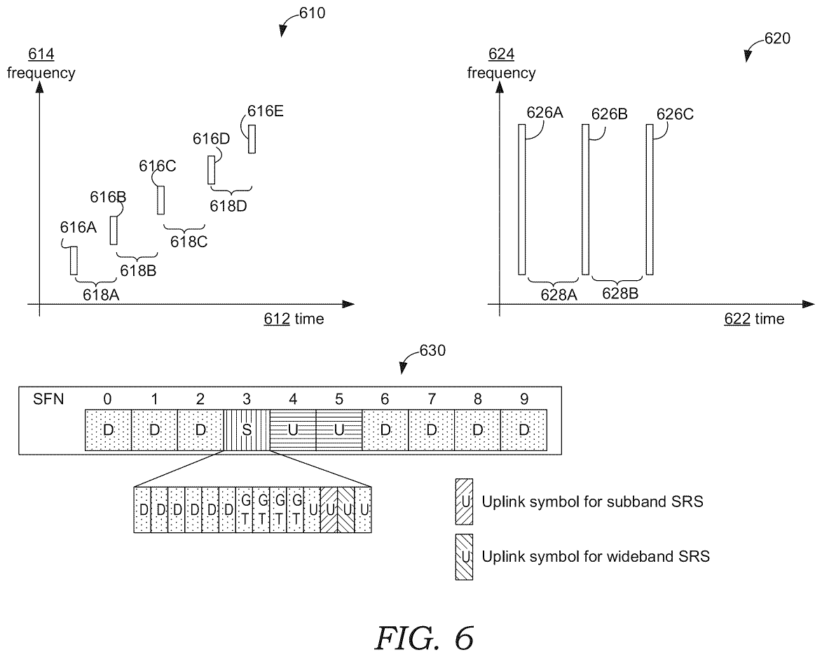

Turning now to FIGS. 1-5, these figures illustrate example operating environments associated with implementation of the SRS allocation hopping techniques, which are provided and discussed in detail with respect to FIGS. 6-9. For example, FIG. 1 includes an example embodiment for user device transmissions to an antenna network node (e.g., an antenna performing massive Multiple-Input Multiple-Output (MIMO) operations). At 102 of FIG. 1, payloads for a user device are transmitted to the network node.

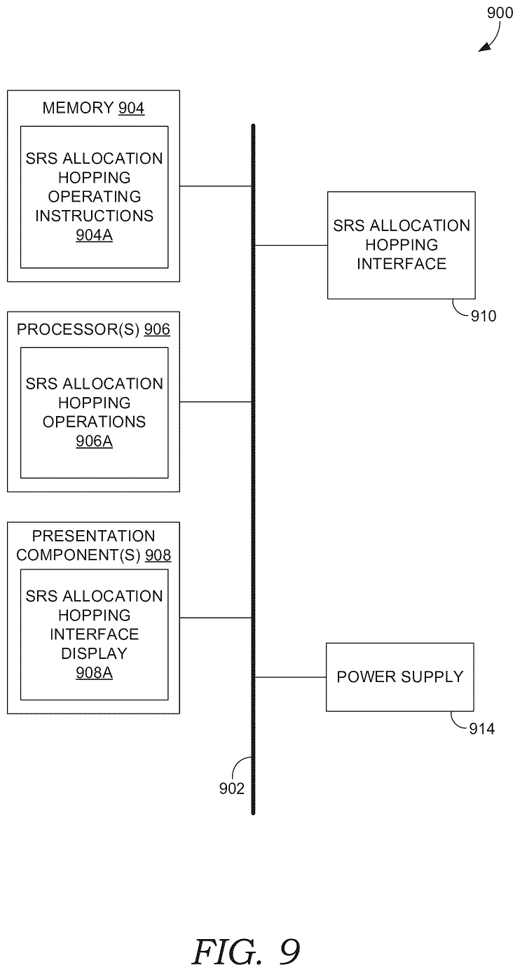

A user device may be a device that has the capability of transmitting or receiving one or more signals (e.g., over a network). In some embodiments, a “user device” may be referred to as a “computing device,” “mobile device,” “user equipment (UE),” “wireless communication device,” a “server,” etc. A user device, in some implementations, may take on a variety of forms, such as a PC, a laptop computer, a tablet, a mobile phone, a PDA, a server, an internet-of-things device, a wireless local loop station, an Internet of Everything device, a machine type communication device, an evolved or enhanced machine type communication device, or any other device that is capable of communicating with a satellite. A user device may be, in an embodiment, user device 900 described herein with respect to FIG. 9.

The payload from 102 is transmitted to a codec (compressor-decompressor) 104, which may encode and compress the payload data (e.g., channel state information (CSI), feedback data, SRS measurement data, etc.) before it is transmitted to modulation at 106. By way of example, the codec may prepare the payload data for transmission by removing redundant data and compressing the data to reduce the amount of information that is transmitted to modulation at 106. At 106, modulation may comprise mapping the compressed data onto a radio frequency carrier, so that the modulated signal may be transmitted over the air to the base station. After modulation, the modulated signal is transmitted for a beamforming weighted value at 108 (e.g., a calculation of a downlink digital beamforming weight using uplink channel estimation), which is then transmitted for a Resource Element (RE) level sum 110 (e.g., the total energy or power accumulated across the resource elements after the modulation and beamforming weight application) for transmission power understanding and signal quality at the receiver.

At 112, a calibration computation may be performed for adjusting the system's transmitted signal (e.g., to account for factors that may affect the signal quality). At 114, Inverse Fast Fourier Transform (IFFT) may be applied for converting the signal from one domain to another domain. At 116, pulse shaping (P/S) may be applied (e.g., for shaping a time-domain signal to minimize inter-symbol interference and reduce out-of-band emissions). At 118, Intermediate Frequency/Radio Frequency (IF/RF) may be applied prior to transmission to the antenna network node.

In embodiments, the SRS allocation hopping techniques (discussed in detail with respect to FIGS. 6-9) can improve upon various steps illustrated in FIG. 1 as the uplink from the user device (e.g., the SRS transmission) is transmitted to the antenna network node. For example, the calibration computation can be improved based on the factors previously affecting the signal quality being improved by one or more of the SRS allocation hopping techniques. As another example, the inter-symbol interference and out-of-band emissions can be further reduced based on the one or more of the SRS allocation hopping techniques.

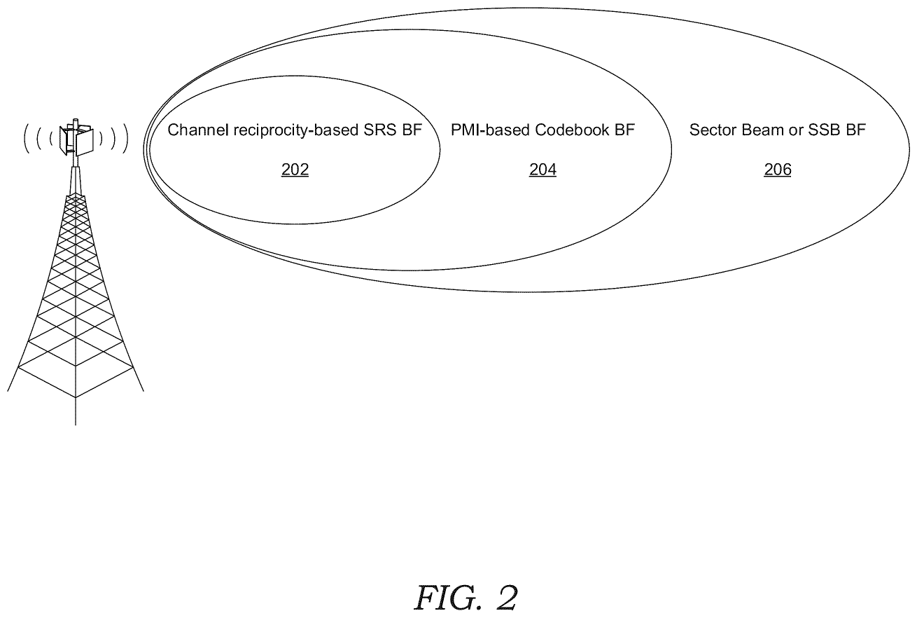

FIG. 2 includes illustrations of the differences among channel reciprocity-based SRS beamforming 202, PMI-based codebook beamforming 204, and sector beam or SSB beamforming 206. As discussed above, channel reciprocity-based SRS beamforming 202 coverage does not reach as far as other beamforming techniques (e.g., PMI-based codebook beamforming 204, and sector beam or SSB beamforming 206) because of user equipment SRS transmission power being limited (e.g., 23 dBm or 26 dBm) for uplink.

As an example, a 100 MHz SRS transmission may have a corresponding UE SRS transmission power spectral density of 23 dBm/273 physical resource blocks (PRBs), whereas PMI-based codebook beamforming 204 and sector beam or SSB beamforming 206 have a corresponding feedback transmission power density at 23 dBm/1 PRB or higher. As such, user devices can transmit PMI or SSB feedback signals to a network node (e.g., gNodeB) from much further away than UEs transmitting SRS signals.

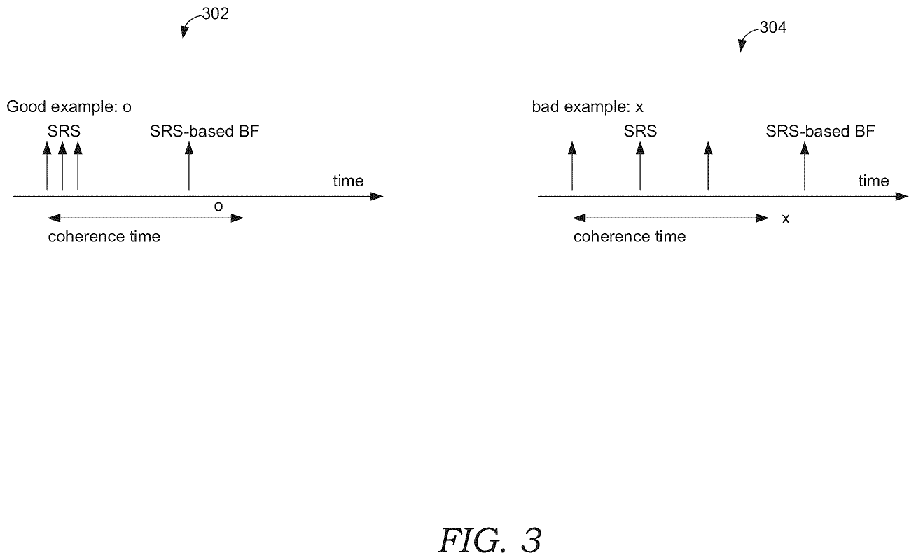

FIG. 3 illustrates a good example 302 and a bad example 304 of channel reciprocity-based SRS beamforming where uplink channel quality scanning and beamforming is to be completed within channel coherence time. As illustrated in the good example 302, the SRS uplink channel quality scanning and the SRS-based beamforming (BF) are completed within the channel coherence time, whereas in the bad example 304, the SRS uplink channel quality scanning was completed within the channel coherence time but the SRS-based beamforming was not completed within the channel coherence time.

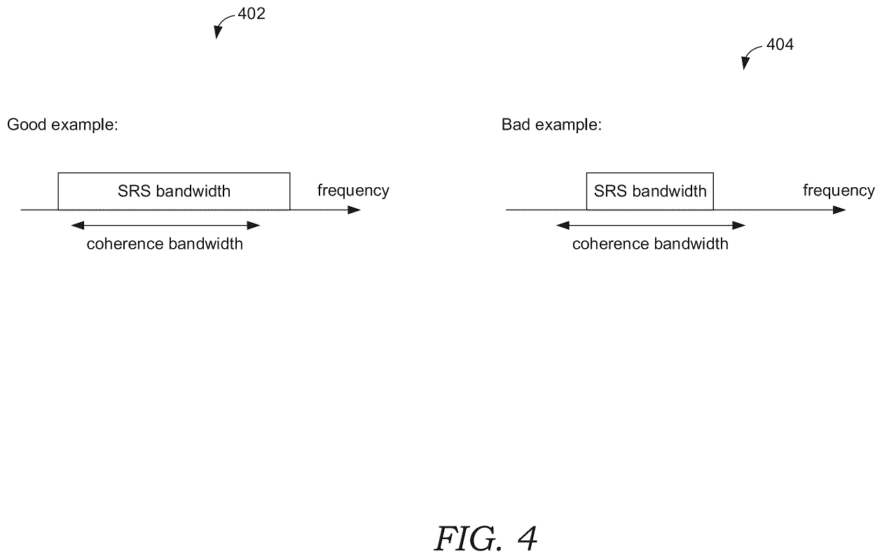

User devices with high mobility (e.g., driving in a car) can have shorter channel coherence time periods, which results in the bad example 304. Additionally, communication networks with higher speeds (e.g., 5G) can also have shorter channel coherence time periods, which results in the bad example 304. In addition, environmental factors and higher frequency bands that experience faster fading may also lead to shorter channel coherence time periods, resulting in the bad example 304. FIG. 4 similarly includes a good example 402 and a bad example 404 for uplink channel quality scanning that should be larger than the channel coherence bandwidth (e.g., the frequency range that a channel response (fading characteristics) remains almost constant, or the frequency range that a signal experiences about the same amount of fading or attenuation).

Embodiments of the present technology can improve upon these technological problems associated with the bad example 304 of FIG. 3 and the bad example 404 of FIG. 4 (e.g., based on UE SRS transmission power limitations of traditional methods). For example, the methods, systems, media, techniques, etc., provided for SRS allocation hopping may include improvements on the ability of network nodes to receive SRS transmissions from UEs in ways that traditional methods have not allowed or provided.

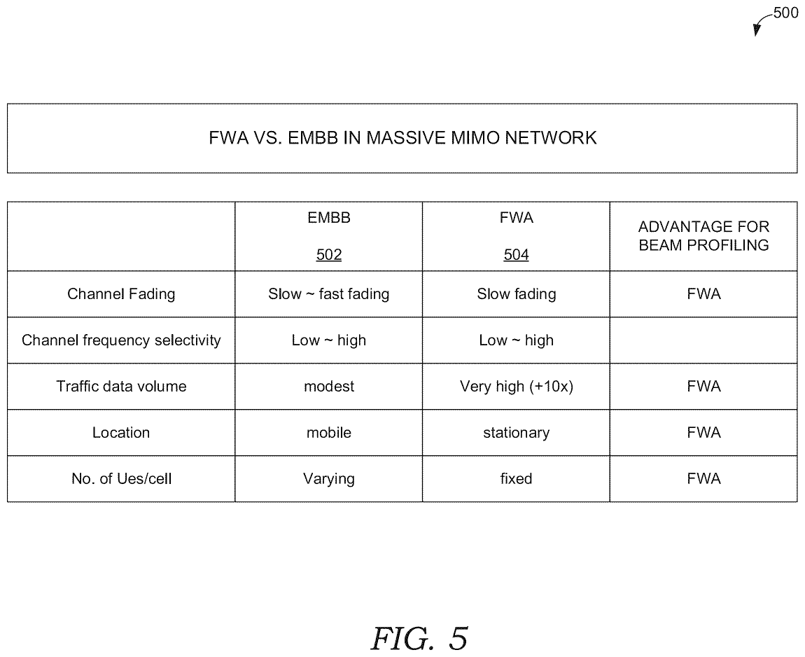

FIG. 5 illustrates table 500, which illustrates differences between FWA and eMBB devices (e.g., in a massive MIMO network). For example, an FWA device, which is generally stationary, may have a longer channel coherence time than the eMBB device and a larger channel coherence bandwidth than the eMBB device. As such, in some embodiments, different particular user devices may have different particular SRS allocation hopping techniques, as discussed further herein.

FIG. 6 includes different example techniques for SRS allocation hopping associated with channel reciprocity-based SRS beamforming. For example, graph 610 includes a SRS allocation hopping technique for an FWA device (or another type of device having a mobility rate below a threshold). In embodiments, a network node (e.g., a network device or component that provides or facilitates a network function, such as radio access, core network management, user device connectivity, etc.) may identify a user device operating in TDD and determine that the user device is an FWA user device (or another type of device having a mobility rate below a threshold). Based on this, the network node may cause the SRS allocation hopping (e.g., by way of assigned particular uplink radio resources) to include SRS transmissions by the FWA device (e.g., SRS transmissions 616A-616E), so that each subsequent SRS transmission has a smaller amount of physical resource blocks than a previous SRS transmission.

By way of illustration, the SRS transmissions 616A-616E occur over time 612, and each subsequent SRS transmission (e.g., SRS transmission 616B being subsequent to 616A, SRS transmission 616C being subsequent to 616B, SRS transmission 616D being subsequent to 616C, and SRS transmission 616E being subsequent to 616D) corresponds to a higher frequency, as illustrated by frequency 614. For example, each subsequent SRS transmission is caused to occur at a higher frequency than the previous SRS transmission (e.g., SRS transmission 616C corresponds to a higher frequency than SRS transmission 616B, and SRS transmission 616E corresponds to a higher frequency than SRS transmission 616D).

In embodiments, the SRS allocation hopping depicted in graph 610 includes an allocation of SRS with smaller physical resource blocks (PRBs) each time in the frequency hopping pattern to scan the entire channel bandwidth. For example, each subsequent SRS transmission may have a smaller amount of physical resource blocks than a previous SRS transmission (e.g., SRS transmission 616B having smaller amount of physical resource blocks than SRS transmission 616A, SRS transmission 616C having smaller amount of physical resource blocks than SRS transmission 616B, SRS transmission 616D having smaller amount of physical resource blocks than SRS transmission 616C, and SRS transmission 616E having smaller amount of physical resource blocks than SRS transmission 616D). In this way, the SRS transmissions (e.g., SRS transmissions 616A-616E), in totality, include a scanning of the entire channel bandwidth.

In embodiments, the periodicity 618A between the SRS transmission 616A and the SRS transmission 616B may be the same periodicity (e.g., 20 milliseconds) as periodicities 618B-618D. In this way, each SRS transmission may be caused to occur within a predetermined time frame for all of the SRS transmissions 616A-616E. Additionally, based on the SRS transmissions having the same periodicity (e.g., 20 milliseconds), the network node may receive the SRS transmissions (e.g., receiving the SRS transmission 616A at a first time, the SRS transmission 616B at a second time, the SRS transmission 616C at a third time, the SRS transmission 616D at a fourth time, and the SRS transmission 616E at a fifth time, wherein each of the periodicities 618A-618D are equal amounts of time).

Graph 620 includes a SRS allocation hopping technique for an eMBB device (or another type of device having a mobility rate above a threshold). In embodiments, a network node (e.g., gNodeB, eNodeB, etc.) may identify a user device operating in TDD and determine that the user device is an eMBB user device (or another type of device having a mobility rate above a threshold). Based on this, the network node may cause the SRS allocation hopping (e.g., by way of assigned particular uplink radio resources) to include SRS transmissions by the eMBB device (e.g., SRS transmissions 626A-626C), so that each of the SRS transmissions have a total amount of physical resource blocks (i.e., the same amount of physical resource blocks).

By way of illustration, the SRS transmissions 626A-626C occur over time 622, and each subsequent SRS transmission (e.g., SRS transmission 626B being subsequent to 626A, SRS transmission 626C being subsequent to 626B) corresponds to the same frequency, as illustrated by frequency 624. For example, each subsequent SRS transmission is caused to occur the same frequency as the previous SRS transmission (e.g., SRS transmission 626C corresponds to the same frequency as SRS transmission 626B, and SRS transmission 626B corresponds to the same frequency as SRS transmission 626A).

In embodiments, the SRS allocation hopping depicted in graph 620 includes an allocation of SRS with an entirety of the physical resource blocks (PRBs) each time in this frequency hopping pattern to scan the entire channel bandwidth. For example, each SRS transmission may have the same amount of physical resource blocks according to this frequency hopping pattern (e.g., SRS transmission 626A having the entirety of the PRBs, SRS transmission 626B having the entirety of the PRBs, and SRS transmission 626C having the entirety of the PRBs). In this way, the SRS transmissions (e.g., SRS transmissions 626A-626C), individually and in totality, include a scanning of the entire channel bandwidth. Additionally, the network node may receive a set of SRS transmissions, based on this particular SRS allocation hopping, from the eMBB device that each measured the entire channel bandwidth.

In embodiments, the periodicity 628A between the SRS transmission 626A and the SRS transmission 626B may be the same periodicity (e.g., 20 milliseconds) as periodicity 628B. In this way, each SRS transmission may be caused to occur within a predetermined time frame for all of the SRS transmissions 626A-626C. Additionally, based on the SRS transmissions having the same periodicity (e.g., 20 milliseconds), the network node may receive the SRS transmissions (e.g., receiving the SRS transmission 626A at a first time, the SRS transmission 626B at a second time, and the SRS transmission 626C at a third time, wherein each of the periodicities 628A-628B are equal amounts of time).

As illustrated in FIG. 6, these SRS allocation techniques support sub-band SRS allocation for FWA user devices or other devices having a mobility below a threshold upon identifying this device (e.g., by using an International Mobile Equipment Identity (IMEI) received from this device). Additionally, these SRS allocation techniques support wide-band SRS allocation for eMBB user devices or other devices having a mobility above a threshold upon identifying this device (e.g., by using an IMEI received from this device). As another example, diagram 630 illustrates that these SRS allocation hopping techniques support one or more dedicated uplink symbols in TDD special slot for sub-band SRS allocation (which is different than that of the wide-band SRS). Additionally or alternatively, these SRS allocation hopping techniques support one or more dedicated uplink symbols in uplink slot for sub-band SRS allocation (which is different than that of the wide-band SRS). These SRS allocation hopping techniques may also support one or more dedicated uplink symbols in TDD special slot for wide-band SRS allocation (which is different than that of the sub-band SRS). Additionally or alternatively, these SRS allocation hopping techniques may also support one or more dedicated uplink symbols in TDD uplink slot for wide-band SRS allocation (which is different than that of the sub-band SRS).

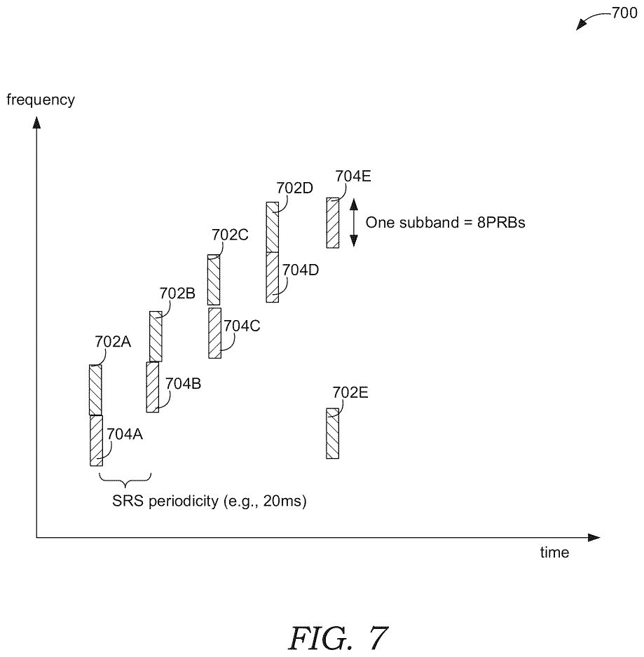

FIG. 7 includes another SRS allocation hopping technique for an FWA device or a device having a mobility below a threshold. For example, graph 700 illustrates an example of one sub-band allocation for each FWA device. In embodiments, an FWA device may be assigned one or multiple sub-bands for SRS transmissions. Each sub-band may include eight consecutive PRBs. In embodiments of allocating multiple sub-bands for each FWA device, the multiple sub-bands may be consecutive, or they may be spread across an entire channel bandwidth.

For example, the network node may cause the FWA device, through assignment of one or multiple sub-bands for SRS transmissions, to perform the SRS allocation hopping based on an equation of Y(n)=a*X(n)+b, where b=Modulation k (Physical Cell Identity (PCI)), where X(n) is nth event of time slot, where “a” is the slope of the frequency, and Y is the location of the physical resource block (e.g., for the narrowband sounding). This equation for a particular frequency hopping of the SRS transmissions reduces or avoids SRS signal collision that causes uplink interference to increase. As an example, the frequency associated with the graph 700 corresponds to a different portion of the spectrum depending on the time slot. The graph (from left to right) initiates at n=0 for the first FWA device having a first SRS transmission 702A. A second FWA device may have a first transmission 704A.

Based on the equation, the first FWA device may have a second SRS transmission 702B, a third SRS transmission 702C, a fourth SRS transmission 702D, and a fifth SRS transmission 702E. Based on the equation, the second FWA device may have a second SRS transmission 704B, a third SRS transmission 704C, a fourth SRS transmission 704D, and a fifth SRS transmission 704E. As illustrated in example graph 700, the fifth SRS transmission 704E by the second FWA device corresponds to a higher frequency than the fifth SRS transmission 702E by the first FWA device, whereas the remaining SRS transmissions by the first FWA device (SRS transmissions 702A-702D) correspond to a higher frequency than the other transmissions (SRS transmissions 704A-704D) by the second FWA device.

### Example Flowchart

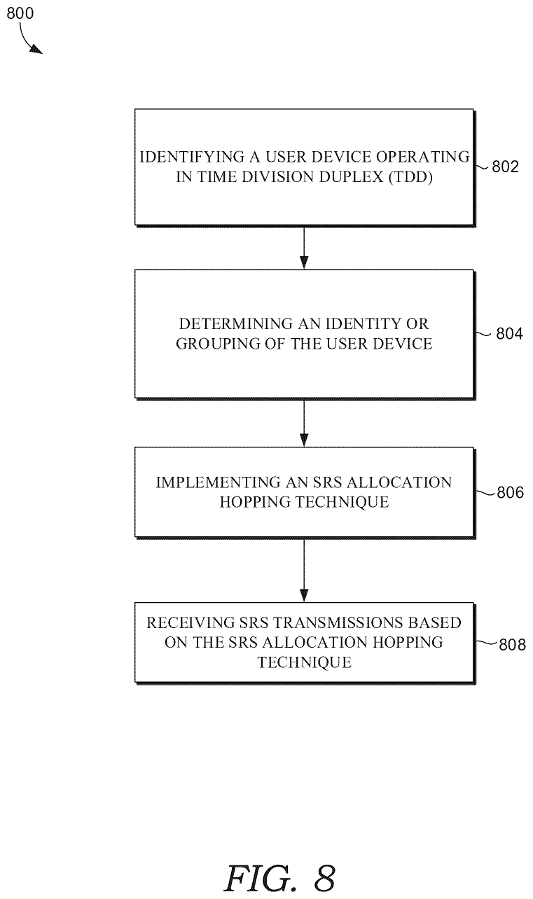

Having described the example embodiments discussed above, an example flowchart 800 is described below with respect to FIG. 8. Example flowchart 800 begins at step 802 with identifying a user device operating in Time Division Duplex (TDD). Step 804 includes determining an identity or grouping for the user device (e.g., whether the user device is an FWA device, an eMBB device, whether the user device has a mobility above or below a threshold, etc.). Based on this, at step 806, the user device is caused to implement SRS allocation hopping (e.g., caused to transmit SRS measurements based on a particular frequency hopping pattern). At 808, the network node receives the SRS measurements based on the SRS allocation hopping technique.

In embodiments, the method may comprise determining the grouping or identity for the user device is an FWA device and causing the SRS allocation hopping to include SRS transmissions by the FWA device, such that each subsequent SRS transmission has a smaller amount of physical resource blocks than a previous SRS transmission (e.g., the SRS transmission 616B of FIG. 6 having smaller amount of physical resource blocks than SRS transmission 616A, SRS transmission 616C having smaller amount of physical resource blocks than SRS transmission 616B, SRS transmission 616D having smaller amount of physical resource blocks than SRS transmission 616C, and SRS transmission 616E having smaller amount of physical resource blocks than SRS transmission 616D).

In some embodiments, each SRS transmission is caused to occur within a predetermined time frame for all of the SRS transmissions (e.g., the periodicity 618A of FIG. 6 between the SRS transmission 616A and the SRS transmission 616B may be the same periodicity). In some embodiments, each subsequent SRS transmission is caused to occur at a higher frequency than the previous SRS transmission (e.g., SRS transmission 616C of FIG. 6 corresponds to a higher frequency than SRS transmission 616B, SRS transmission 616E corresponds to a higher frequency than SRS transmission 616D, SRS transmission 616D corresponds to a higher frequency than SRS transmission 616C, and SRS transmission 616B corresponds to a higher frequency than SRS transmission 616A). In some embodiments, the SRS allocation hopping may include an SRS measurement based on a first amount of physical resource blocks and a subsequent SRS measurement based on a second amount of physical resource blocks that is a smaller amount than the first amount.

In embodiments, the method may comprise determining the grouping or identity for the user device is an eMBB device and causing the SRS allocation hopping to include SRS transmissions by the eMBB device, each of the SRS transmissions having a total amount of physical resource blocks (e.g., SRS transmissions 626A-626C of FIG. 6 each having a total amount of physical resource blocks (i.e., the same amount of physical resource blocks)). In some embodiments, each of the SRS transmissions (e.g., SRS transmissions 626A-626C of FIG. 6) are received by the network node within a predetermined time frame (e.g., the periodicity 628A and 628B of FIG. 6 may be the same periodicity (e.g., 20 milliseconds)). In some embodiments, each of the SRS transmissions correspond to a same frequency (e.g., associated with frequency 624 of FIG. 6).

### Example User Device

Referring now to FIG. 9, a diagram is depicted of an example user device suitable for use in implementations of the present disclosure. In particular, the example environment is shown and designated generally as user device 900. User device 900 is but one example of a suitable computing environment and is not intended to suggest any limitation as to the scope of use or functionality of the invention. Neither should user device 900 be interpreted as having any dependency or requirement relating to any one or combination of components illustrated.

The implementations of the present disclosure may be described in the general context of computer code or machine-useable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. Implementations of the present disclosure may be practiced in a variety of system configurations, including handheld devices, consumer electronics, general-purpose computers, specialty computing devices, etc. Implementations of the present disclosure may also be practiced in distributed computing environments where tasks are performed by remote-processing devices that are linked through a network.

With continued reference to FIG. 9, user device 900 includes bus 902 that directly or indirectly couples the following devices: memory 904, one or more processors 906, one or more presentation components 908, SRS allocation hopping interface 910, and power supply 914. The memory 904 may include SRS allocation hopping operating instructions 904A, which may be executed by the processor(s) 906 to perform SRS allocation hopping operations 906A.

Although the components of FIG. 9 are shown with lines for the sake of clarity, in reality, delineating various components is not so clear, and metaphorically, the lines would more accurately be grey and fuzzy. For example, one may consider a presentation component, such as a display device to be one of input/output components. As another example, processors, such as one or more processors 906, have memory. The present disclosure hereof recognizes that such is the nature of the art, and reiterates that FIG. 9 is merely illustrative of an example computing environment for a user device that may be used in connection with one or more implementations of the present disclosure. Additionally, distinction is not made between such categories as “workstation,” “server,” “laptop,” “handheld device,” etc., as all are contemplated within the scope of FIG. 9 and refer to “computer” or “user device.” In yet another example, bus 902 may represent what may be one or more busses (such as an address bus, data bus, or combination thereof).

User device 900 typically includes a variety of computer-readable media. Computer-readable media may be any available media that may be accessed by user device 900 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information, such as computer-readable instructions, data structures, program modules, or other data.

Computer storage media may include RAM, ROM, EEPROM, flash memory or other memory technology, CD-ROM, DVD or other optical disk storage, magnetic cassettes, magnetic tape, magnetic disk storage, or other magnetic storage devices. Computer storage media does not comprise a propagated data signal.

Communication media typically embodies computer-readable instructions, data structures, program modules, or other data in a modulated data signal, such as a carrier wave or other transport mechanism and includes any information delivery media. The term “modulated data signal” means a signal that has one or more of its characteristics set or changed in such a manner as to encode information in the signal. By way of example, and not limitation, communication media includes wired media, such as a wired network or direct-wired connection, and wireless media such as acoustic, RF, infrared, and other wireless media. Combinations of any of the above should also be included within the scope of computer-readable media.

In embodiments, memory 904 includes computer-storage media in the form of volatile and/or nonvolatile memory. Memory 904 may be removable, non-removable, or a combination thereof. Examples of memory 904 may include solid-state memory, hard drives, optical-disc drives, etc., or one or more combinations thereof. The SRS allocation hopping operating instructions 904A stored in memory 904 may be used by the one or more processors 906 to cause the one or more processors 906 to perform SRS allocation hopping operations 906A.

In some embodiments, the SRS allocation hopping operations 906A may include transmitting an indication (e.g., synchronization signal(s), a connection request) to a network node identifying the user device 900 as operating in Time Division Duplex (TDD). The SRS allocation hopping operations 906A may include transmitting an indication (e.g., an International Mobile Equipment Identity (IMEI), an International Mobile Subscriber Identity (IMSI), a Temporary Mobile Subscriber Identity (TMSI), a Mobile Station International Subscriber Directory Number (MSISDN), a software version identifier, a Radio Network Temporary Identifier (RNTI), a Subscriber Identifier (SID), a Public Land Mobile Network (PLMN) identifier, a Global Unique Temporary Identifier (GUTI), a UE identifier, etc.) to a network node identifying the user device 900 as a particular grouped device, an FWA device, an eMBB device, etc. For example, the IMEI may identify the user device 900 as a FWA device or an eMBB device.

The SRS allocation hopping operations 906A may include receiving instructions from a network node (e.g., receiving assigned uplink resources) to take SRS measurements within a particular time frame (e.g., to take an SRS measurement within every 20 milliseconds for a particular duration) based on a particular amount of physical resource blocks. For example, the SRS allocation hopping may involve transmitting SRS transmissions by an FWA user device, each subsequent SRS transmission having a smaller amount of physical resource blocks than a previous SRS transmission. As another example, each SRS transmission may be transmitted within a predetermined time frame (e.g., the same time frame for each SRS measurement), and each SRS transmission may be for a different frequency. For example, each subsequent SRS transmission may correspond to a higher frequency than the previous SRS transmission.

As another example implementation, the SRS allocation hopping may involve transmitting SRS transmissions by an eMBB user device, wherein each of the SRS transmissions have a total amount of physical resource blocks (e.g., each of the SRS transmissions correspond to the same number of physical resource blocks, so that the eMBB device is measuring an entire channel bandwidth). In embodiments, the SRS transmissions from the eMBB device may each correspond to the same frequency band. In embodiments, each of the SRS measurements for the same frequency band may be taken within a particular time frame (e.g., an SRS measurement and transmission within every 20 milliseconds for a particular duration). In some embodiments, the instructions from a network node (e.g., user device 900 receiving assigned uplink resources) may cause the user device 900 to perform the SRS allocation hopping based on an equation of Y(n)=a*X(n)+b, where b=Modulation k (Physical Cell Identity (PCI)), where X(n) is nth event of time slot, where “a” is the slope of the frequency, and Y is the location of the physical resource block (e.g., for the narrowband sounding).

User device 900 also includes one or more processors 906 that read data from various entities, such as bus 902, memory 904, or input/output components of the user device 900. Examples of one or more processors 906 may include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, other types of processors or other suitable hardware configured to perform the SRS allocation hopping operations 906A using the SRS allocation hopping operating instructions 904A (e.g., received uplink resources assigned by a network node), etc., or one or more combinations thereof.

One or more presentation components 908 may present (e.g., to a person or other device) SRS allocation hopping operating instructions 904A, performed SRS allocation hopping operations 906A, SRS measurement data, etc. Examples of the one or more presentation components 908 may include a display device, speaker, printing component, vibrating component, etc. Examples of the SRS allocation hopping interface(s) 908A may include graph 700 of FIG. 7, one or more portions of FIG. 6, etc. Other examples of SRS allocation hopping interface(s) 908A may include an alarm or notification that the SRS allocation hopping has been implemented or updated.

In some embodiments, the user device 900 includes input/output ports that allow user device 900 to be logically coupled to input/output components or other devices. In some embodiments, only a portion of a plurality of input/output components may be built into user device 900. Illustrative input/output components may include a microphone, joystick, game pad, satellite dish, scanner, printer, wireless device, etc., or one or more combinations thereof. In some embodiments, the one or more presentation components may provide an indication (e.g., via the display or vibrating component) that the user device 900 is performing one or more of the SRS allocation hopping operations 906A.

In some embodiments, the user device 900 may have a radio that facilitates communication with a wireless telecommunications network. Illustrative wireless telecommunications technologies may include CDMA, GPRS, TDMA, GSM, and the like. This radio might additionally or alternatively facilitate other types of wireless communications including Wi-Fi, WiMAX, LTE, or other VoIP communications. As can be appreciated, in various embodiments, the radio may be configured to support multiple technologies and/or multiple radios may be utilized to support multiple technologies. By way of example, the radio may be configured to support an 8-element MIMO antenna configuration for 5G smartphones or another number of elements for various antenna configurations for other generation smartphones or user devices for implementing the SRS allocation hopping operations 906A.

A wireless telecommunications network might include an array of devices, which are not shown so as to not obscure more relevant aspects of the invention. Components, such as a base station, a communications tower, one or more satellites, other access points (as well as other network components), or one or more combinations thereof, may provide wireless connectivity in some embodiments.

Many different arrangements of the various components depicted, as well as components not shown, are possible without departing from the scope of the claims below. Embodiments in this disclosure are described with the intent to be illustrative rather than restrictive. Alternative embodiments will become apparent to readers of this disclosure after and because of reading it. Alternative means of implementing the aforementioned may be completed without departing from the scope of the claims below. Certain features and sub-combinations are of utility and may be employed without reference to other features and sub-combinations and are contemplated within the scope of the claims.

In the preceding Detailed Description, reference is made to the accompanying drawings which form a part hereof wherein like numerals designate like parts throughout, and in which is shown, by way of illustration, embodiments that may be practiced. It is to be understood that other embodiments may be utilized and structural or logical changes may be made without departing from the scope of the present disclosure. Therefore, the preceding detailed description is not to be taken in the limiting sense, and the scope of embodiments is defined by the appended claims and their equivalents.

The invention claimed is:

1. A method comprising:
identifying a user device operating in Time Division Duplex (TDD);
determining a grouping for the user device; and
based on the grouping and the user device operating in TDD, causing the user device to implement Sounding Reference Signal (SRS) allocation hopping.

2. The method according to claim 1, further comprising:
determining that the grouping for the user device is a fixed wireless access (FWA) device; and
based on the user device being the FWA device, causing the SRS allocation hopping to include SRS transmissions by the FWA device, each subsequent SRS transmission having a smaller amount of physical resource blocks than a previous SRS transmission.

3. The method according to claim 2, wherein each SRS transmission is caused to occur within a predetermined time frame for all of the SRS transmissions.

4. The method according to claim 2, wherein each subsequent SRS transmission is caused to occur at a higher frequency than the previous SRS transmission.

5. The method according to claim 1, further comprising:
determining that the grouping for the user device is an Enhanced Mobile Broadband device (eMBB); and
based on the user device being an eMBB device, causing the SRS allocation hopping to include SRS transmissions by the eMBB device, each of the SRS transmissions having a total amount of physical resource blocks.

6. The method according to claim 5, further comprising receiving a set of SRS transmissions, based on the SRS allocation hopping, from the eMBB device that each measured an entire channel bandwidth.

7. The method according to claim 6, wherein each of the set of SRS transmissions are received within a predetermined time frame.

8. The method according to claim 6, wherein each of the set of SRS transmissions correspond to a same frequency.

9. The method according to claim 1, further comprising:
causing the SRS allocation hopping to occur based on an equation of Y(n)=a*X(n)+b, where b=Mod k (PCI); and
receiving SRS transmissions from the user device based on the equation.

10. One or more computer storage media having computer-executable instructions embodied thereon, that when executed by at least one processor, cause the at least one processor to perform a method comprising:
identifying a user device operating in Time Division Duplex (TDD);
determining a grouping for the user device;
based on the grouping and the user device operating in TDD, causing the user device to implement Sounding Reference Signal (SRS) allocation hopping; and
receiving SRS transmissions from the user device based on the SRS allocation hopping.

11. The media of claim 10, the method further comprising:
determining the grouping for the user device is a fixed wireless access (FWA) device; and
based on the user device being a FWA device, causing the SRS allocation hopping to include an SRS measurement based on a first amount of physical resource blocks and a subsequent SRS measurement based on a second amount of physical resource blocks that is a smaller amount than the first amount.

12. The media of claim 11, further comprising causing the SRS allocation hopping to include a third SRS measurement based on a third amount of physical resource blocks and a fourth SRS measurement based on a fourth amount of physical resource blocks, wherein the third amount is a smaller amount than the second amount, and the fourth amount is a smaller amount than the third amount.

13. The media of claim 12, further comprising receiving the SRS transmissions including the SRS measurement at a first time, the subsequent SRS measurement at a second time, the third SRS measurement at a third time, and the fourth SRS measurement at a fourth time, wherein durations between the first time and the second time, the second time and the third time, and third time and the fourth time are equal amounts of time.

14. The media of claim 10, the method further comprising:
determining the grouping for the user device is an Enhanced Mobile Broadband device (eMBB); and
based on the user device being an eMBB device, causing the SRS allocation hopping to include SRS measurements each based on a total amount of physical resource blocks.

15. The media of claim 14, the method further comprising receiving the SRS transmissions, including the SRS measurements, each within a subsequent time frame, each corresponding to an entire channel bandwidth.

16. The media of claim 10, the method further comprising:
causing the SRS allocation hopping to occur based on an equation of Y(n)=a*X(n)+b, where b=Mod k (PCI); and
receiving the SRS transmissions from the user device, each within a subsequent time frame, based on the equation.

17. A system comprising at least one processor and computer storage media having computer-executable instructions embodied thereon, that when executed by the at least one processor, cause the at least one processor to:
determine an identity for a user device operating in Time Division Duplex (TDD);
based on the identity and the user device operating in TDD, cause the user device to implement Sounding Reference Signal (SRS) allocation hopping; and
receive SRS transmissions from the user device based on the SRS allocation hopping.

18. The system according to claim 17, the at least one processor further caused to:
cause the SRS allocation hopping to occur based on an equation of Y(n)=a*X(n)+b, where b=Mod k (PCI); and
receive the SRS transmissions from the user device, each within a subsequent time frame, based on the equation.

19. The system according to claim 17, the at least one processor further caused to:
determine the identity is an Enhanced Mobile Broadband device (eMBB); and
based on the user device being an eMBB device, cause the SRS allocation hopping to include SRS measurements each based on a total amount of physical resource blocks.

20. The system according to claim 17, the at least one processor further caused to:
determine that the identity is a fixed wireless access (FWA) device; and
based on the user device being the FWA device, cause the SRS allocation hopping to include each subsequent SRS transmission of the SRS transmissions to have a smaller amount of physical resource blocks than a previous SRS transmission.
